(19) United States
(12) Patent Application Publication
(10) Pub. No.: US 2015/0348074 A1
(43) Pub. Date: Dec. 3, 2015

(54) METHOD FOR PERFORMING REVERSE MAPPING POSITIONING ANALYSIS

(71) Applicant: Arvind RANGASWAMY, University Park, PA (US)

(72) Inventor: Arvind RANGASWAMY, University Park, PA (US)

(21) Appl. No.: 14/532,735

(22) Filed: Nov. 4, 2014

Related U.S. Application Data
(60) Provisional application No. 62/003,318, filed on May 27, 2014.

(51) Int. Cl. G06Q 30/02

(52) U.S. Cl. CPC G06Q 30/0204

(57) ABSTRACT

A method for performing a reverse mapping analysis is provided. The method includes storing at least one of perceptual data and preference data. The method includes generating a visual representation of at least one of a perceptual map and a preference map. The method includes receiving, from a user, at least one of a relocated first position of one of the plurality of targets on the visual representation, a second position of a new target on the visual representation, and a change of a set of attribute levels of one of the plurality of targets. The method includes calculating and providing, corresponding to the receiving step, at least one of a first set of attribute levels for the first position, a second set of attribute levels for the second position, and a third position on the visual representation for the change of set of attribute levels.

### FIELD OF THE DISCLOSURE

This disclosure relates generally to a positioning analysis and more particularly to a method for performing a reverse mapping positioning analysis.

### BACKGROUND

Positioning analysis incorporates several mathematical mapping techniques that enable users to develop differentiation and positioning strategies for their brands or products. By using positioning analysis, users can visualize the competitive structure of their markets as perceived by their customers. Data required for mapping are customer perceptions of existing brands/products and new product concepts along various attributes, customer preferences for products, or measures of behavioral response of customers toward the brands e.g., current market shares of the products.

Positioning analysis can be based on perceptual mapping and preference mapping techniques. Perceptual-mapping helps users understand how customers view their product(s) relative to competitive products. Perceptual mapping technique depicts a data matrix that includes the average perceptions of different targets (brands, products or offerings) in a customer segment. The resulting map can provide a visual representation, e.g., in two dimensions, of how the customer segment perceives all the targets. Preference mapping technique helps users understand the market value (e.g., market share, revenue, profit) associated with any specific position on the map.

An important analytic formulation in psychology is the notion of perceptual mapping, which takes individuals' perceptions of various targets (e.g., brands, people, presidential candidates) on various attributes or characteristics, and transforms those perceptions into a “perceptual map.” A perceptual map is a visual representation of how the various targets are positioned relative to each other, the extent to which various attributes drive those positions, as well as the relationships between the attributes themselves in terms of how the individuals view the relationships between the attributes.

For the purpose of simplicity, unless otherwise indicated herein, reference numeral 10 refers to a singular or a plural number of respondents while a specific respondent may be referred to with reference numeral 10 followed by a letter of the alphabet, e.g., 10a. Reference numeral 110 refers to a singular or a plural number of attributes while a specific attribute may be referred to with reference numeral 110 followed by a letter of the alphabet, e.g., 110a. Similarly, reference numeral 120 refers to a singular or a plural number of targets while a specific target may be referred to with reference numeral 120 followed by a letter of the alphabet, e.g., 120a.

FIG. 1 is a graphic showing an example of a perceptual map 101 of how various brands 120 of cars are perceived by consumers on various attributes. Referring to FIG. 1, the “X” axis represents a composite attribute that we call “Image” and the “Y” axis represents a composite attribute we call “Performance.” Various car brands 120 are plotted on the graph based on perceptual mapping analysis. The brands are perceived by consumers on fifteen (15) attributes 110, such as roomy 110a, and quiet 110b. FIG. 1 depicts relative positions between various brands 120 of cars and fifteen (15) attributes 110 on X-Y plane. The X axis and Y axis merely reflect relative orientations. An angle between two lines of the attributes 110 shows a correlation between the two attributes 110.

For instance, an angle between attributes roomy 110a and quiet 110b is smaller than that of roomy 110a and poorly built 110c. This indicates that attributes roomy 110a and quiet 110b are closer together in customer perceptions than that of roomy 110a and poorly built 110c. Brand Saab 120a is depicted relatively farther along the attribute roomy 110a than the attribute unreliable 110d on the perceptual map. This means that brand Saab 120a is perceived by consumers as roomy 110a rather than unreliable 110d.

Perceptual mapping can be applied in a wide range of situations for modeling all types of human perceptions. Marketers and business analysts can use perceptual maps to derive positioning strategies for companies. In fact, this type of mapping can also be applied to a range of situations that do not involve perceptions, but the data have a structure similar to perceptual data. An example is to view “genotypes” as similar to targets, and the characteristics of those individuals as similar to attributes. Preference information add a “value dimension” to perceptual maps by indicating which positions on the map are important for driving peoples' s choices.

FIG. 2 is a graphic showing an example of a preference map 102 with a plurality of preference vectors 130 (shown in dashed lines) onto the perceptual map. The preference map 102 introduces preference vectors 130 or ideal points (not shown) for each customer (e.g., a survey respondent or a target market) onto a perceptual map 102. The ideal point represents the location of the (hypothetical) product that most appeals to a specific customer.

Perceptual maps and preference maps merely analyze and represent a given data. Perceptual maps and preference maps fail to provide any necessary attribute levels of one or more targets that would allow a specific target to achieve a certain position on the map that users desire.

### SUMMARY

In view of the aforementioned problems, the present disclosure provides a method for performing a reverse mapping positioning analysis. Advantages of the present disclosed invention include the ability to find specific new positions for a target brand that are attractive (given the positions of the remaining brands), and to determine the changes in attribute values that would allow such attractive positions to be realized.

A method for performing a reverse mapping analysis is provided. The method includes storing at least one of perceptual data and preference data in a computer memory storage, the perceptual data including a plurality of attributes of a plurality of targets, wherein the perceptual data are reflective of perceptions of a plurality of respondents for different attribute levels of the attributes, and the preference data including a plurality of preferences of the plurality of targets, wherein the preference data are reflective of preferences of the plurality of respondents for different targets; generating a visual representation of at least one of a perceptual map and a preference map on a display device, wherein the perceptual map is reflective of the perceptual data, and wherein the preference map is reflective of the preference data, receiving, from a user, at least one of a relocated first position of one of the plurality of targets on the visual representation, a second position of a new target on the visual representation, and a change of a set of attribute levels of one of the plurality of targets, calculating and providing, correspondingly, at least one of a first set of attribute levels for the first position, a second set of attribute levels for the second position, and a third position on the visual representation for the change of set of attribute levels.

The input data for the perceptual map are an m by n matrix S, where m is the number of the attributes and n is the number of the targets, where U is an m×m matrix containing the orthonormal basis vectors, where B is an m×n matrix, and where the transpose of an orthogonal matrix V′ is an n×n matrix, and wherein S, U, B, and V′ satisfy the equation: S=UBV′.

the method of calculating and providing a second set of attribute levels sⱼ can be calculated for the given first position vⱼ. The plurality of attributes are an m by n matrix S*, a first r columns of V represent the first position, a first r columns of UB represent the attribute vectors, and S*, UB, and V′ satisfy the equation: S*=(UB)ᵣ(V′)ᵣ, wherein jth row of matrix V is vⱼ, a column of S* is sⱼ, and wherein vⱼ, B, U, and s satisfy the equation: sⱼ=(UB)ᵣvⱼ.

The method of calculating and providing a second position vⱼ on the visual representation can be calculated from the given first set of attribute levels sⱼ. The plurality of attributes are an m by n matrix S*, a first r columns of V represent the second position, a first r columns of UB represent the attribute vectors, and S*, UB, and V′ satisfy the equation S*=(UB)ᵣ(V′)ᵣ, wherein jth row of matrix V is vⱼ, a column of S* is sⱼ, and wherein vⱼ, B, U, and s satisfy vⱼ=B⁻U′sⱼ.

The first position vₙ₊₁ on the visual representation is a position of a new target, and wherein attribute values sₙ₊₁ of the new target can be computed by an equation of:

sₙ₊₁=(UB)ᵣvₙ₊₁.

The first set of attribute levels sₙ₊₁ is given for a new target position vₙ₊₁, and the new target position vₙ₊₁ can be computed by an equation of:

vₙ₊₁=w₁B⁻U′s₁+w₂B⁻U′s₂+ . . . +wₙB⁻U′sₙ.

The predicted value of sₙ₊₁ is sₙ₊₁(p) , where sₙ₊₁(p)=w₁s₁+w₂s₂+ . . . +wₙsₙ, and average value of sₙ₊₁ is sₙ₊₁(A). SSR (sum of squares regression) can be computed by taking the difference between each element of sₙ₊₁ and the corresponding sₙ₊₁(p), squaring and adding up all the squares. SSE (sum of squares for error) can be calculated by taking the difference between each element of sₙ₊₁ and the corresponding sₙ₊₁(A), squaring and adding up all the squares. R²=1−(SSR/SSE) and if R²>0.8, the new target position vₙ₊₁ can be obtained by an equation of vₙ₊₁=w₁B⁻U′s₁+w₂B⁻U′s₂+ . . . +wₙB⁻U′sₙ.

### BRIEF DESCRIPTION OF THE DRAWINGS

FIG. 1 is a prior art graphic showing an example of a perceptual map showing how various brands of cars are perceived by consumers with respect to various attributes.

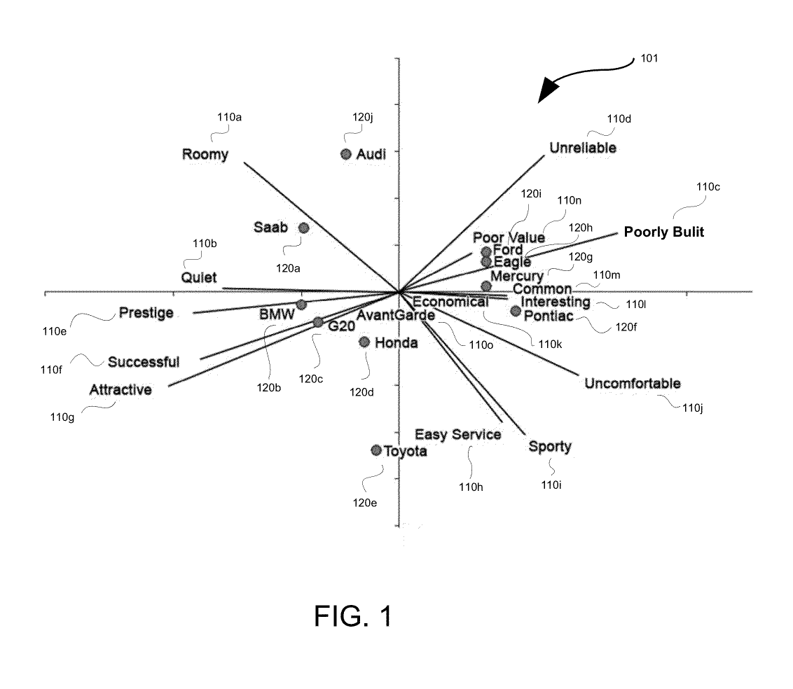

FIG. 2 is a prior art graphic showing an example of a preference map that includes a perceptual map which includes a plurality of preference vectors superimposed onto the perceptual map.

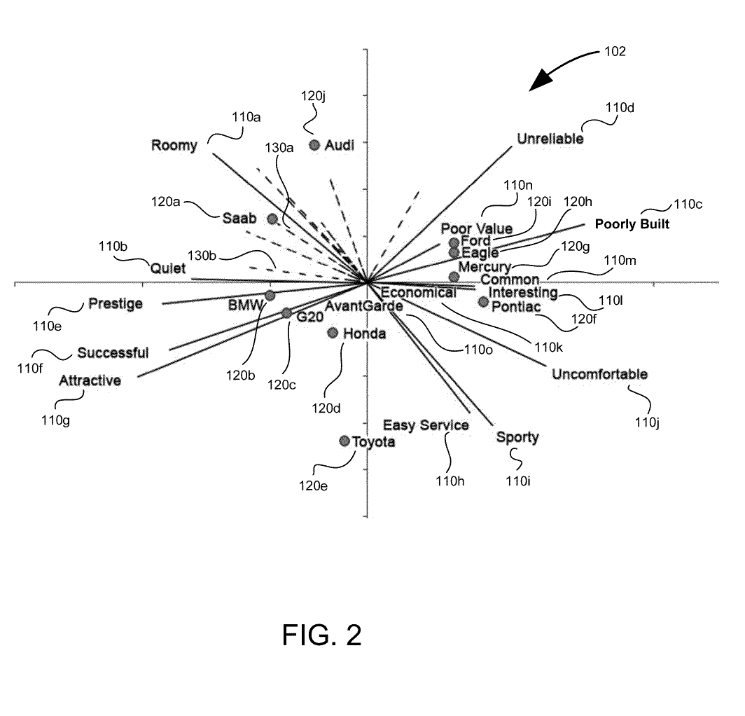

FIG. 3 is a graphic showing reverse mapping positions on the perceptual and preference map along with various attributes according to an embodiment of the present disclosure.

FIG. 4 is a graphic showing a reverse mapping position on the perceptual and preference map along with various attributes according to another embodiment of the present disclosure.

FIG. 5 is a graphic showing a reverse mapped position on the perceptual and preference map of FIG. 4 along with various attributes.

FIG. 6 is a diagrammatic illustration of a system for performing a reverse mapped position analysis according to an exemplary disclosed embodiment.

### DETAILED DESCRIPTION

Reference will now be made in detail to embodiments, examples of which are illustrated in the accompanying drawings, wherein like reference numerals refer to the like elements throughout the several views. In this regard, the present embodiments may have different forms and should not be construed as being limited to the descriptions set forth herein. Accordingly, the embodiments are merely described below, by referring to the figures, to explain aspects of the present description. Terms used herein are for descriptive purposes only and are not intended to limit the scope of the disclosure. The terms “comprises” and/or “comprising” are used to specify the presence of stated elements, steps, operations, and/or components, but do not preclude the presence or addition of one or more other elements, steps, operations, and/or components. The terms “first,” “second,” and the like may be used to describe various elements, but do not limit the elements. Such terms are only used to distinguish one element from another. These and/or other aspects become apparent and are more readily appreciated by those of ordinary skill in the art from the following description of embodiments of the present disclosure, taken in conjunction with the accompanying drawings. The figures depict embodiments of the present disclosure for purposes of illustration only. One skilled in the art will readily recognize from the following description that alternative embodiments of the structures and methods illustrated herein may be employed without departing from the principles of the disclosure described herein.

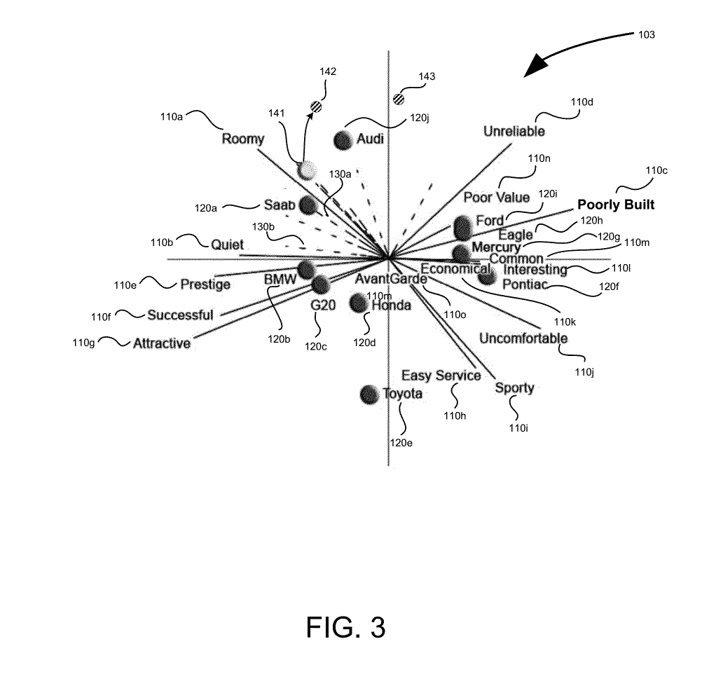

FIG. 3 is a reverse mapping graphic 103 with reverse mapping positions 141, 142 and 143. Graphic 103 is a Cartesian type graph in which an “X” or horizontal axis 102 refers to a “Quality” dimension and a “Y” or vertical axis 104 refers to a “Convenience” dimension. Reverse mapping graphic includes perceptual map 101, preference map 102, and reverse mapping positions 141, 142, and 143. In other words, reverse mapping graphic 103 includes attributes 110, targets 120, and perferences 130, and reverse mapping positions 141, 142, and 143. In FIG. 3, exemplary targets are various brands of popular automobiles.

Reverse mapping graphic 100 are reflective of exemplary data obtained from a plural number of respondents. A typical approach has been to collect a number of completed survey questionnaires that are reflective of a target population. A method for performing a reverse mapping analysis can be performed on a non-transitory computer-readable storage medium storing a program that, when executed by a computer, causes the computer to perform a process. The relative positions of the targets 120 is determined by perceptual mapping analysis. The exemplary data obtained from respondents are described herein in conjunction with Tables 1-1, 1-2, 2-1, 2-2, 3-1, 3-2, and 4-11 below.

Attributes 110 are something attributed as belonging to targets 120, such as attractive 110a, quiet 110b, unreliable 110c, poorly built 110d, interesting 110e, sporty 110f, uncomfortable 110g, roomy 110h, easy to service 110i, prestige 110j, common 110k, economical 110l, successful 110m, avant garde 110n.

Targets 120 are selected objects of the marketing analysis, such as stationery brands, people, and presidential candidates.

Perceptual data describe the market space occupied by various targets 120 (products or offerings), as perceived by customers. These data refer to customers' perceptions of targets 120 along various attributes 110. For example, referring to FIG. 3, it illustrates how customers perceive Saab 120a on various attributes 110, such as attractive 110a, quiet 110b, unreliable 110c, poorly built 110d, interesting 110e, sporty 110f, uncomfortable 110g, roomy 110h, easy service 110i, prestige 110j, common 110k, economical 110l, successful 110m, and avant garde 110n.

Referring to Table 1-1 and Table 1-2 below, 1-to-9 attribute scores for each target 120 (or brand) from individual respondent are shown. A car having an attribute score 1 means that respondent perceives that car to have the lowest value of that attribute (e.g., Attractive) and an attribute score of 9 indicates that the respondent perceives that car to have the highest value of that attribute In this example, John 10a provides his perceptions on fifteen (15) for each of ten (10) brands of cars.

TABLE 1-1
John 10a

| | Brands | | | | |
|---|---|---|---|---|---|
| | Saab | BMW | G20 | Honda | Toyota |
| Attributes | 120a | 120b | 120c | 120d | 120e |
| Roomy 110a | 3 | 4 | 4 | 4 | 3 |
| Quiet 110b | 5 | 6 | 7 | 5 | 4 |
| Poorly Built 110c | 3 | 1 | 3 | 3 | 1 |
| Unreliable 110d | 5 | 2 | 3 | 3 | 2 |
| Prestige 110e | 5 | 8 | 6 | 7 | 7 |
| Successful 110f | 8 | 9 | 6 | 7 | 9 |
| Attractive 110g | 4 | 6 | 6 | 5 | 4 |
| Easy Service 110h | 2 | 5 | 3 | 5 | 7 |
| Sporty 110i | 2 | 6 | 6 | 6 | 7 |
| Uncomfortable 110j | 5 | 4 | 3 | 3 | 4 |
| Economical 110k | 3 | 2 | 4 | 5 | 6 |
| Interesting 110l | 2 | 3 | 6 | 4 | 4 |
| Common 110m | 2 | 2 | 6 | 6 | 5 |
| AvantGrarde 110n | 8 | 3 | 3 | 6 | 7 |
| Preference score | 3 | 7 | 4 | 7 | 6 |

TABLE 1-2
John 10a

| | Brands | | | | |
|---|---|---|---|---|---|
| | Poniac | Mercury | Eagle | Ford | Audi |
| Attributes | 120f | 120g | 120h | 120i | 120j |
| Roomy 110a | 2 | 4 | 2 | 4 | 7 |
| Quiet 110b | 1 | 3 | 4 | 5 | 6 |
| Poorly Built 110c | 4 | 5 | 5 | 4 | 2 |
| Unreliable 110d | 6 | 4 | 7 | 3 | 4 |
| Prestige 110e | 4 | 2 | 1 | 4 | 8 |
| Successful 110f | 5 | 2 | 2 | 5 | 6 |
| Attractive 110g | 2 | 4 | 4 | 5 | 6 |
| Easy Service 110h | 6 | 5 | 5 | 7 | 4 |
| Sporty 110i | 7 | 5 | 5 | 6 | 3 |
| Uncomfortable 110j | 5 | 6 | 4 | 5 | 3 |
| Economical 110k | 2 | 6 | 5 | 4 | 4 |
| Interesting 110l | 6 | 2 | 3 | 5 | 5 |
| Common 110m | 4 | 3 | 6 | 4 | 4 |
| AvantGrarde 110n | 3 | 6 | 4 | 4 | 3 |
| Preference score | 1 | 2 | 4 | 4 | 8 |

Various targets 120, such as car brands, can be perceived by a plural number of respondents 10 on various attributes 110. Referring to Tables 2-1, and 2-2 below, targets 120, e.g., car brands, are perceived by respondents 10 on fifteen (15) attributes 110, including roomy 110a, and quiet 110b. Each attribute value for each target 120 is an average attribute score each target 120 achieves on each attribute 110 from plural number of respondents 10.

TABLE 2-1
(Perceptual Data Matrix)

| | Brands | | | | |
|---|---|---|---|---|---|
| | Saab | BMW | G20 | Honda | Toyota |
| Attributes | 120a | 120b | 120c | 120d | 120e |
| Roomy 110a | 5.8 | 4.3 | 4.2 | 3.9 | 3.5 |
| Quiet 110b | 4.8 | 5 | 6.3 | 5.4 | 4.2 |
| Poorly Built 110c | 2.8 | 1.8 | 1.6 | 2.8 | 2.1 |
| Unreliable 110d | 3.7 | 2.3 | 2.9 | 3.2 | 2 |
| Prestige 110e | 5.4 | 6.4 | 6.4 | 4.7 | 5.3 |
| Successful 110f | 5.3 | 5.9 | 5.3 | 5.6 | 5.5 |
| Attractive 110g | 5.3 | 5.7 | 5.6 | 5.2 | 5.6 |
| Easy Service 110h | 3.8 | 4.1 | 4.6 | 5 | 4.9 |
| Sporty 110i | 4.3 | 4.1 | 4.1 | 5.1 | 6.2 |
| Uncomfortable 110j | 2.5 | 3.5 | 3.2 | 3.3 | 3.7 |
| Economical 110k | 4.3 | 4.3 | 3.6 | 5 | 3.2 |
| Interesting 110l | 3.4 | 3.3 | 3.6 | 3.4 | 4.3 |
| Common 110m | 1.9 | 2.8 | 3.5 | 3.9 | 2.9 |
| AvantGrarde 110n | 4.7 | 3.7 | 4.3 | 3.9 | 4.9 |
| Average Preference | 7.5 | 8.3 | 6 | 6 | 6.1 |
| score | | | | | |

TABLE 2-2

| | Brands | | | | |
|---|---|---|---|---|---|
| | Pontiac | Mercury | Eagle | Ford | Audi |
| Attributes | 120f | 120g | 120h | 120i | 120j |
| Roomy 110a | 3.3 | 3.6 | 3.6 | 3.9 | 5.3 |
| Quiet 110b | 2.8 | 3.3 | 3.5 | 3.6 | 5.2 |
| Poorly Built 110c | 4.4 | 4.3 | 4.3 | 4.2 | 2.6 |
| Unreliable 110d | 3.9 | 4 | 4.3 | 4.2 | 3.7 |
| Prestige 110e | 3.8 | 3.3 | 2.8 | 3.5 | 5.6 |
| Successful 110f | 4.4 | 3.9 | 3.7 | 4.2 | 5 |
| Attractive 110g | 3.9 | 3.9 | 4 | 4 | 4.6 |
| Easy Service 110h | 4.7 | 4.6 | 4.6 | 4.9 | 3.5 |
| Sporty 110i | 5.7 | 5.2 | 4.9 | 4.9 | 3.8 |
| Uncomfortable 110j | 4.3 | 4.4 | 4 | 4 | 2.4 |
| Economical 110k | 3.1 | 4.6 | 4.9 | 3.7 | 3.6 |
| Interesting 110l | 5.4 | 3.9 | 3.9 | 5 | 4 |
| Common 110m | 4.3 | 3.9 | 4.3 | 3.6 | 3.4 |
| AvantGrarde 110n | 4.1 | 4.5 | 4.4 | 3.6 | 3.6 |
| Average Preference | 1.2 | 1.7 | 3.3 | 2.1 | 6 |
| score | | | | | |

Based on data given in Table 2-1 and Table 2-2, a perceptual map can be developed via several existing mapping methods. The perceptual map can be applied in a wide range of situations for modeling all types of human perceptions. Marketers and business analysts can use perceptual maps to derive positioning strategies for companies. In fact, this type of mapping can also be applied to a range of situations that do not involve perceptions, but the data have a structure similar to perceptual data.

An example is to view “genotypes” as similar to targets, and the characteristics of those individuals as similar to attributes. Preference information adds a “value dimension” to perceptual maps by indicating which positions on a map are important for driving people's (e.g., customers') choices. That is, with preference information incorporated onto a perceptual map, the user would be able to compute the value (e.g., market share, revenue, profit) that could be associated with any position on a map.

For the purpose of simplicity, unless otherwise indicated herein, reference numeral 130 refers to a singular or a plural number of preferences. A specific preference may be referred to with one digit number, e.g., 131 or with reference numeral 130 followed by an alphabet, e.g., 130a.

Preferences 130 refer to customer or respondent 10 preferences 130 for the various targets 120, such as brands and offerings. Therefore, Preferences 130 clarify whether the resepondent 10 prefers target A or target B. Preferences 130 may translate into purchases of the preferred target in no constraints (e.g., budget) preventing customers from expressing their preferences through purchase. If preference data are not available, instead of preference data, past purchase or market share data can be used to represent customer or segment preferences.

Referring to Table 3 below, where there are ten (10) respondents 10, preference score data obtained for each brand from each respondent are shown. 1-to-9 preference scores are provided to indicate a degree of preference of each target. Each preference score has 9 response degree ranging from most preferred (9) and least preferred (1).

TABLE 3-1
(Preference Data Matrix)

| | Targets 120 | | | | |
|---|---|---|---|---|---|
| | Saab | BMW | G20 | Honda | Toyota |
| Respondents 10 | 120a | 120b | 120c | 120d | 120e |
| John 10a | 7 | 9 | 6 | 6 | 6 |
| Mike 10b | 5 | 6 | 7 | 5 | 5 |
| Lori 10c | 6 | 7 | 7 | 8 | 6 |
| Mary 10d | 7 | 7 | 6 | 6 | 5 |
| Radjeep 10e | 6 | 8 | 7 | 5 | 4 |
| Antoine 10f | 6 | 4 | 5 | 6 | 6 |
| Yoshi 10g | 7 | 9 | 7 | 8 | 7 |
| Hubert 10h | 6 | 5 | 4 | 6 | 5 |
| Michael 10i | 4 | 5 | 5 | 5 | 5 |
| Elisabeth 10j | 6 | 7 | 6 | 8 | 4 |

TABLE 3-2
(Preference Data Matrix)

| | Pontiac | Mercury | Eagle | Ford | Audi |
|---|---|---|---|---|---|
| Respondents 10/Targets 120 | 120f | 120g | 120h | 120i | 120j |
| John 10a | 1 | 2 | 3 | 2 | 6 |
| Mike 10b | 3 | 4 | 3 | 6 | 8 |
| Lori 10c | 5 | 3 | 5 | 2 | 4 |
| Mary 10d | 3 | 7 | 4 | 4 | 4 |
| Radjeep 10e | 2 | 6 | 2 | 4 | 8 |
| Antoine 10f | 3 | 4 | 3 | 5 | 7 |
| Yoshi 10g | 6 | 5 | 4 | 3 | 6 |
| Hubert 10h | 2 | 3 | 1 | 5 | 7 |
| Michael 10i | 2 | 3 | 3 | 6 | 6 |
| Elisabeth 10j | 3 | 4 | 1 | 4 | 6 |

FIG. 3 also illustrates a preference map 102 showing a plurality of preference vectors 130 (shown in dashed lines) onto the perceptual map 101. The preference map 102 introduces preference vectors 130 (shown in dashed lines) or ideal points (not shown) for each respondent 10 onto a perceptual map.

The ideal point (not shown) can represent the location of the (hypothetical) product that most appeals to a specific respondent 10. Ideal point (not shown) can denote each respondent's preferences by an “Ideal point” on the map. The closer a target is positioned to a respondent's ideal point, the more preferred that target is compared with a target positioned farther away.

Either one of ideal points (not shown) or preference vectors (shown in dotted lines) for each individual can be introduced into the map in a manner that allows for maximal correspondence between the input preference ratings (or rankings) for the alternatives, and the preference relationships between the alternatives in the resulting combined map of perceptions and preferences. Each individual can have a unique ideal point or a preference vector.

The preference vector e.g. 130a or 130b denotes each respondent's preferences with a vector that represents the direction in which that respondent's preferences increases. In other words, a respondent's “ideal” product can lay as far up the preference vector as possible. For instance, a first customer's preference vector 130a is in a direction where Brand Saab 120a lies farthest along that preference vector 130a, compared to the other brands, and thus Saab 120a can be regarded as the most preferred product for the first customer (from among the products shown on the map). For second customer's preference vector 130b, Audi is the most preferred brand along that preference vector 130b. Nearest brand to the second customer's preference vector 130b is BMW 120b. Thus, it can be analyzed that BMW 120b is the closest existing car brand to the second customer's ideal product.

Preferences vector e.g. 130a or 130b can be converted into market shares using various types of “choice rules” that specify how people convert their preferences into actions in the market place. Two choice rules can typically be used, (1) first-choice (or maximum utility rule) and (2) share of preference rule.

Under the first choice rule, individuals are assumed to act by choosing the target 120 (brand) that they prefer the most. Under the share of preference rule, individuals are assumed to act probabilistically, choosing every target 120 (brand) in proportion to how much it is preferred compared to the other targets 120 (brands), which is relative to the sum of preferences for all brands available for purchase. The first-choice rule is likely to apply most to high-ticket items, and other types of “high-involvement” purchase decisions. The share of preference rule is likely to apply most in the case of low-ticket items or low-involvement purchases.

Non Patent Literature “External Analysis” option in PREFMAP3 (Green and Wind 1973; Muelman, Heiser, and Carroll 1986), is hereby incorporated by reference in their entireties for all purposes. External Analysis mapping is based on the assumption that though a group of individuals has common perceptions of a set of alternatives (i.e., their “average perceptions”), they may have widely differing preferences for these alternatives. For example, some consumers may prefer sporty cars, whereas others may prefer sedans, although both have the perception that a Porsche 911 is a sporty car. The PREFMAP3 model superimposes the preferences of each individual onto a common perceptual map that is derived from the same set of individuals for whom perceptions data are obtained. The superimposition is done in such a way that the stated or known preferences of each customer are maximally recovered from their superimposed positions on the perceptual map. Reverse mapping techniques will also work with other techniques for superimposition, such as joint mapping of perceptions and preferences.

A first reverse mapping position 141 refers to a specific position on a map in which a user of the map desire to obtain the underlying attribute levels that correspond to that position.

Reverse mapping is of tremendous value in many applications, particularly for marketers and business analysts. For example, perceptual mapping is merely able to transform data about how various car brands compare on various attributes 110 observed by respondents 10 into key underlying dimensions of a map. Reverse mapping, on the other hand, takes a first reverse mapping position 141 on the map, and determines the attribute 110 levels (e.g., roomy 110a, quiet 110b, poorly built 110c, unreliable 110d, prestige 110e, successful 110f, attractive 110g, easy service 110h, sporty 110i, uncomfortable 110j, economical 110k, interesting 110l, common 110m, and avant-garde 110n) that will allow the target 120 (or brands such as, Saab 120a, BMW 120b, G20 120c, Honda 120d, Toyota 120e, Poniac 120f, Mercury 120g, Eagle 120h, Ford 120i, and Audi 120j)) to achieve that first reverse mapping position 141.

Referring to FIG. 3, the preferences are depicted in dashed lines, using the preference vector 130. Market share for Saab 120a under the first-choice rule is 10%. Saab 120a has been re-positioned to first reverse mapping position 141. In first reverse mapping position 141, Saab 120a can garner 30% market share with an increase in market share of 20% from its previous position. Such an increase can be accomplished, for instance, by changing attribute quiet 110b from 4.8 to 5.72, a reduction in its attribute sporty 110i from 4.3 to 4.11, and so on. Referring to FIG. 3, for first reverse mapping position 141 of the new brand or repositioned Saab, the corresponding set of attribute levels can be calculated and provided as shown in Table 4 below. The user can also directly manipulate the attribute levels so that the user can determine the changes to market share that could be accomplished by changes to specific attributes.

TABLE 4

Targets 120

| | | First Reverse |
|---|---|---|
| | Saab | mapping position |
| Attributes 110 | 120a | 141 |
| Roomy 110a | 5.8 | 4.87 |
| Quiet 110b | 4.8 | 5.72 |
| Poorly Built 110c | 2.8 | 2.00 |
| Unreliable 110d | 3.7 | 3.00 |
| Prestige 110e | 5.4 | 5.11 |
| Successful 110f | 5.3 | 5.56 |
| Attractive 110g | 5.3 | 5.58 |
| Easy Service 110h | 3.8 | 4.16 |
| Sporty 110i | 4.3 | 4.11 |
| Uncomfortable 110j | 2.5 | 2.84 |
| Economical 110k | 4.3 | 4.65 |
| Interesting 110l | 3.4 | 3.22 |
| Common 110m | 1.9 | 2.87 |
| AvantGrarde 110n | 4.7 | 4.20 |

According to another embodiment of the present disclosure, the user can also directly manipulate or input the attribute levels rather than repositioning the target 120. The computer program can calculate and output the location of first reverse mapping position 141 that corresponds to the attribute levels the user input. The computer program also can produce a market share that corresponds to the attribute levels the user input. Thus, the company can determine the changes to market share that could be accomplished by changes to specific attributes 110.

For instance, the user can change attribute uncomfortable 110j from 2.84 to 2.50 as shown in Table 5. That is, the car is made to be more comfortable. Such a change results in an increase in market share for Saab from 30% to 40%.

TABLE 5

Targets 120

| | | First Reverse | |
|---|---|---|---|
| | Saab | mapping position | Attribute |
| Attributes 110 | 120a | 141 | level change |
| Roomy 110a | 5.8 | 4.87 | 4.87 |
| Quiet 110b | 4.8 | 5.72 | 5.72 |
| Poorly Built 110c | 2.8 | 2.00 | 2.00 |
| Unreliable 110d | 3.7 | 3.00 | 3.00 |
| Prestige 110e | 5.4 | 5.11 | 5.11 |
| Successful 110f | 5.3 | 5.56 | 5.56 |
| Attractive 110g | 5.3 | 5.58 | 5.58 |
| Easy Service 110h | 3.8 | 4.16 | 4.16 |
| Sporty 110i | 4.3 | 4.11 | 4.11 |
| Uncomfortable 110j | 2.5 | 2.84 | 2.50 |
| Economical 110k | 4.3 | 4.65 | 4.65 |
| Interesting 110l | 3.4 | 2.97 | 3.32 |
| Common 110m | 1.9 | 2.87 | 2.87 |
| AvantGrarde 110n | 4.7 | 4.20 | 4.20 |

Referring to FIG. 3, it is depicted that the first reverse mapping position 141 is relocated to second reverse mapping position 142. According to the first-choice rule or the share of preference rule, market share for second reverse mapping position 142 can be calculated. In second reverse mapping position 142, Saab 120a gains no additional market share as compared to its previous position.

According to another embodiment of the present disclosure, the user can also introduce a third reverse mapping position 143 for a new target 120 (brand) on the map. Referring to FIG. 3, if the user desires to create a new target, the user can choose the third reverse mapping position 143 on the map. Since the third reverse mapping position 143 is not a relocated position of a pre-existing target 120, there are no predefined attribute values for the new target 120 (new brand). However, from the given third reverse mapping position 143, the corresponding attribute values can be calculated from the known set of attribute data on the map, as shown in Table 6 below. Furthermore, according to the first-choice rule or the share of preference rule, market share for third reverse mapping position 143 can be calculated. In this example, the calculated share for the new brand is 20%, which is less than 30% obtained by Saab, although the attribute values are similar to that of the first repositioning map 141. This is because when the new brand is introduced, Saab already is in its original location and garners its original 10% share.

TABLE 6

Targets 120

| | First Reverse | Third reverse |
|---|---|---|
| | mapping position | mapping position |
| Attributes 110 | 141 | 143 for the New brand |
| Roomy 110a | 4.87 | 4.94 |
| Quiet 110b | 5.72 | 5.63 |
| Poorly Built 110c | 2.00 | 2.04 |
| Unreliable 110d | 3.00 | 3.05 |
| Prestige 110e | 5.11 | 5.92 |
| Successful 110f | 5.56 | 5.54 |
| Attractive 110g | 5.58 | 5.50 |
| Easy Service 110h | 4.16 | 4.09 |
| Sporty 110i | 4.11 | 4.09 |
| Uncomfortable 110j | 2.84 | 2.80 |
| Economical 110k | 4.65 | 4.41 |
| Interesting 110l | 2.97 | 3.17 |
| Common 110m | 2.87 | 2.84 |
| AvantGrarde 110n | 4.20 | 4.14 |

In contrast, the user can introduce a new target 120 (new brand) by specifying its attributes 110 rather than choosing a specific position on the map. A conventional computer program can calculate a corresponding position for the given set of attribute levels for the new target 120 (new brand) and display the same on the map.

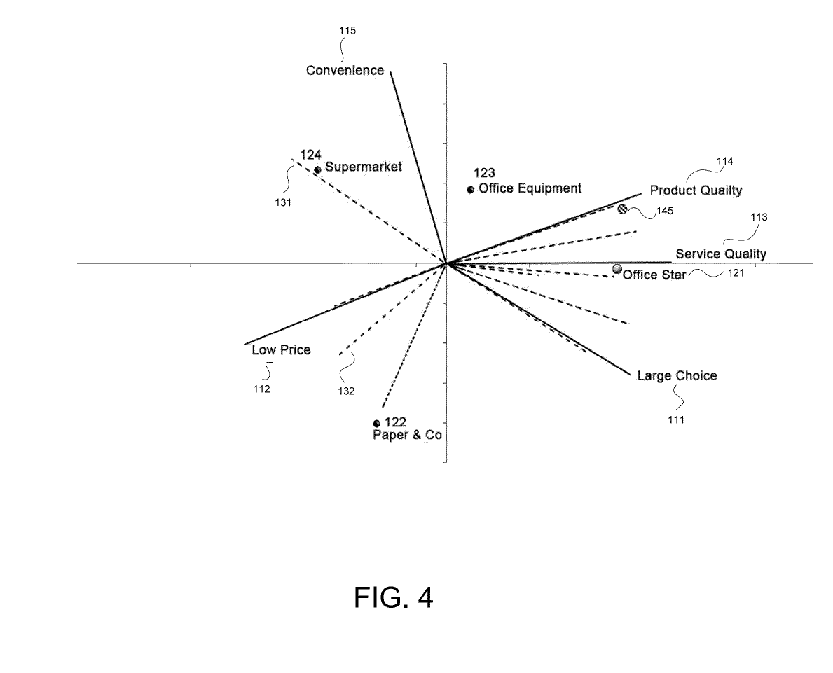

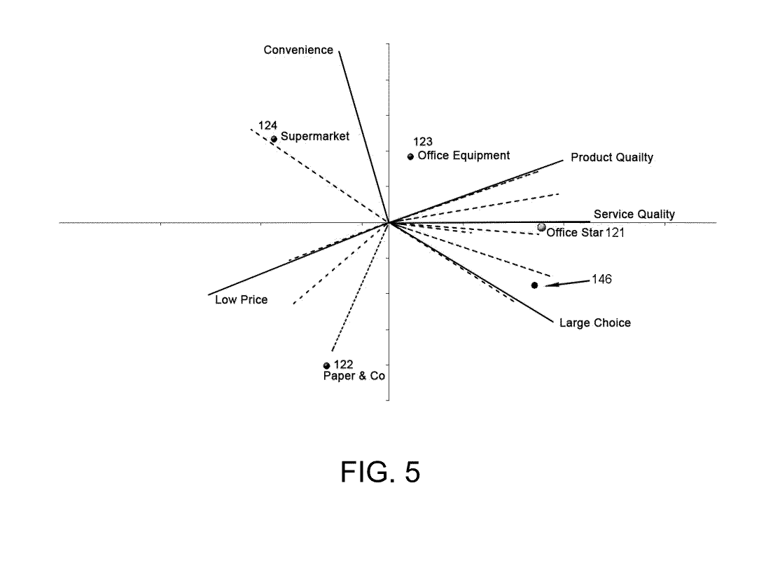

Referring to FIGS. 4 and 5, another example of the present disclosure is described with respect to office supply companies. FIG. 4 is a reverse mapping graphic showing a fourth reverse mapping position 145 on the perceptual and preference map along with various attributes according to an embodiment of the present disclosure.

The attributes includes large choice 111, low prices 112, service quality 113, product quality 114, and convenient 115. The targets are stationery brands including office Star 121, paper & Co 122, office equipment 123, and supermarket 124.

Referring to Table 7 below, attribute scores for each brand from one individual respondent (John 10a) are shown. Four (4) stationery brands are perceived by consumers on five (5) attributes from respondent John 10a. 1-to-5 attribute scores are provided to indicate a degree of perception of each attribute. Each attribute score has 5 response degree ranging from strongly agree (5) and strongly disagree (1).

TABLE 7
John 10a

| | Brands | | | |
|---|---|---|---|---|
| | | | Office | |
| | Office | Paper & | Equipment | Supermarket |
| Attributes | Star 121 | Co 122 | 123 | 124 |
| Large choice 111 | 5 | 4 | 5 | 2 |
| Low prices 112 | 3 | 4 | 4 | 5 |
| Service quality | 3 | 2 | 5 | 3 |
| 113 | | | | |
| Product quality | 2 | 3 | 2 | 2 |
| 114 | | | | |
| Convenience 115 | 1 | 1 | 2 | 4 |
| Preference Score | 5 | 3 | 3 | 1 |
| 130 | | | | |

Various targets 120, such as stationery brands, can be perceived by a plural number of respondents 10 on various attributes 110. Referring to Table 8 below, targets 120, e.g., stationery brands, are perceived by respondents 10 on five (5) attributes 110, including “large choice,” and “low prices.” Each attribute value for each target 120 is an average score each target 120 achieves on each attribute 110 from plural number of respondents 10.

TABLE 8
(Perceptual Data Matrix)

| | Targets 120 | | | |
|---|---|---|---|---|
| | | | Office | |
| | Office | Paper & | Equipment | Supermarket |
| Attributes 110 | Star 121 | Co 122 | 123 | 124 |
| Large choice 111 | 5.52 | 4.4 | 3.9 | 2.3 |
| Low prices 112 | 2.1 | 4.5 | 2.6 | 4.1 |
| Service quality 113 | 4.2 | 2.3 | 3.1 | 1.8 |
| Product quality 114 | 3.7 | 2.6 | 3.1 | 2.9 |
| Convenience 115 | 2.7 | 1.4 | 4.7 | 5.1 |

Referring to Table 9 below, where there are ten (10) respondents 10, preference score data obtained for each brand from each respondent are shown.

TABLE 9
(Preference Data Matrix)

| | Targets 120 | | | |
|---|---|---|---|---|
| | | | Office | |
| | Office | Paper & | Equipment | Supermarket |
| Respondents 10 | Star 121 | Co 122 | 123 | 124 |
| John 10a | 5 | 3 | 3 | 1 |
| Mike 10b | 4 | 3 | 4 | 2 |
| Lori 10c | 4 | 2 | 3 | 2 |
| Mary 10d | 5 | 3 | 5 | 3 |
| Radjeep 10e | 2 | 5 | 3 | 2 |
| Antoine 10f | 4 | 3 | 2 | 2 |
| Yoshi 10g | 3 | 3 | 4 | 2 |
| Hubert 10h | 1 | 2 | 3 | 5 |
| Michael 10i | 2 | 4 | 4 | 3 |
| Elisabeth 10j | 2 | 5 | 4 | 3 |

FIG. 4 also illustrates a preference map showing a plurality of preference vectors 130 (shown in dashed lines) onto the perceptual map. The preference map introduces preference vectors 130 (shown in dashed lines) or ideal points (not shown) for each respondent 10 onto a perceptual map.

The ideal point (not shown) can represent the location of the (hypothetical) product that most appeals to a specific respondent. Ideal point (not shown) can denote each respondent's preferences by an “Ideal point” on the map. The closer a target is positioned to a respondent's ideal point, the more preferred that target is compared with a target positioned farther away.

Either “ideal points (not shown)” or “preference vectors (shown in dashed lines),” one for each individual, can be introduced into the map in a manner that allows for maximal correspondence between the input preference ratings (or rankings) for the alternatives, and the preference relationships between the alternatives in the resulting combined map of perceptions and preferences. Each individual can have a unique ideal point or a preference vector.

Reverse mapping is of tremendous value in many applications, particularly for marketers and business analysts. For example, perceptual mapping is merely able to transform data about how various stationery brands (e.g., OfficeStar, Paper & Co, Office Equipment, Supermarket) compare on various attributes 110 (e.g., large choice, low prices) observed by respondents 10 into key underlying dimensions of a map. Reverse mapping, on the other hand, takes a position on the map, and determines the attribute 110 levels that will allow the target 130 to achieve that position.

Referring to FIG. 4, Office star 121 has been re-positioned to a new location on the map, fourth reverse mapping position 145. In fourth reverse mapping position 145, it can garner 50% market share, an increase of 20 percentage points from its previous position where it has a 30% share. But, more importantly, in fourth reverse mapping position 145, the changes in attributes 110 that are required the target 120 to achieve fourth reverse mapping position 145 can be provided.

TABLE 10

Targets 120

| | Office | Reverse mapping |
|---|---|---|
| Attributes 110 | Star 121 | position 145 |
| Large choice 111 | 5.2 | 5.21 |
| Low prices 112 | 2.1 | 1.72 |
| Service quality 113 | 4.2 | 4.32 |
| Product quality 114 | 3.7 | 3.91 |
| Convenience 115 | 2.7 | 3.66 |

Specifically, such change can be accomplished with a significant change to Convenience 115 perception from 2.7to 3.66, and smaller changes to the other attributes such aslow prices 112 perception from 2.1 to 1.72, and so on.

Instead of repositioning of the target 120, the user can also directly manipulate or input the attribute levels. The computer program can calculate and output the location of first reverse mapping position 140 that corresponds to the attribute levels the user input. The conventional computer program also can produce a market share that corresponds to the attribute levels the user inputs. Thus, the company can determine the changes to market share that could be accomplished by changes to specific attributes 110.

The user can also introduce a fifth reverse mapping position for a new target 120 (brand) on the map. Referring to FIG. 4, for fifth reverse mapping position 146 of the new brand, the corresponding attribute values can be calculated and provided as shown in Table 11 below. In this example, we introduced a new low-priced competitor who is similar to Office Star on other attributes, but offers lower prices. In this market, given the perceptions and preferences of the customers, the new brand is only able to garner 10% share.

TABLE 11

| | Targets 120 |
|---|---|
| | Fifth reverse mapping position |
| Attributes 110 | 146 of the new brand |
| Large choice 111 | 5.20 |
| Low prices 112 | 3.97 |
| Service quality 113 | 4.20 |
| Product quality 114 | 3.70 |
| Convenient 115 | 2.70 |

As another example of reverse mapping analysis, from the political arena, reverse mapping would allow a presidential campaign to determine what specific actions/views taken by a candidate would enable that candidate to be perceived as being strong on foreign policy when that candidate is competing with other candidates who have their own perceptions among the electorate.

Now, it is described how reverse mapping process is performed. For the reverse mapping position analysis, Signular Value Decomposition (SVD) can be used. Equation 1 below presents SVD equation.

S=UBV′ Equation 1:

The input data for the perceptual map can be an m by n matrix S, where m is the number of attributes and n is the number of targets. S is a diagonal matrix and the row-standardized version of the raw data matrix. The row-standardization version ensures that mere changes in the scale by which an attribute is measured does not change the perceptual map.

U is an m×m matrix containing the orthonormal basis vectors. The columns of U are orthonormal eigenvectors of SS′(U^{T}U=U′U=I). Transpose of an orthogonal matrix V′ is an n×n matrix which contains the orthonormal basis vectors, and the columns of V are orthonormal eigenvectors of S′S (V^{T}V=V′V=I).

An eigenvector is a nonzero vector that satisfies equation 2 below. Where A is a square matrix, λ is a scalar, and \vec{v} is the eigenvector. λ is called an eigenvalue.

A\vec{v}=λ\vec{v} Equation 2:

The diagonal matrix B is of size m×n. Matrix B's diagonal entries include the singular values of S, or equivalently, the square roots of the eigenvalues of SS′ and S′S and its off-diagonal entries are equal to 0. The term eigenvalues applies to square matrices and thus, B contains the ordered non-zero square roots of the eigenvalues of SS′ and S′S.

The perceptual map can be obtained by computing U and B, and retaining the first r columns of these matrices for further analysis. The reduction in the dimensionality of the matrices from m or n to r (which can be set to 2 or 3) results in a map displayed in r dimensions (e.g., correspondingly 2 or 3 dimensions). The reduction in the dimensionality of the data can lead to some loss of information, but most of that loss will likely be due to random variations, and not systematic differences between the targets. Thus, in transpose matrix V′, the first r rows are needed for further analysis.

With these restrictions, least squares approximation can be applied to get attribute values S* from equation 3.

S*=(UB)ᵣ(V′)ᵣ Equation 3:

The size of attribute values S* is equal to m×n because, for instance, the dimensionality of the attribute values matrix S* will be given by m×r×r×r×r×n, which is equal to m×n. In the map the first r columns of V represent the target points, and the first r columns of UB represent the attribute vectors where r is the dimensionality of the map.

According to an aspect of the present disclosure, after altering the position of a target on the map, corresponding changes in attribute values S* can be computed. The jth row of matrix V, which is equivalent with a jth column of transpose matrix Vᵣ′, is denoted as vⱼ. If the user changes the position of a target on the map, then vⱼ values will change. Then, the changed value of S* can be computed from the equation 3 above. A column of S* is denoted as sⱼ, where j represents a specific target whose position is being changed. Then, sⱼ=(UB)ᵣvⱼ. Because all off-diagonal elements of B are equal to zero, we can compute S* by using just the first r columns of UB, and the first r columns of V′. Dimension of sⱼ equals m×1(=m×r×r×r×r×1).

According to another aspect of the present disclosure, after altering target attribute values in the data, the user also can see the corresponding changes on the map. The locational change in the map for a change in one or more attribute values for a target j can be obtained. From the equation 3, the inverse of an orthonormal matrix is its transpose (U′U=I), and thus, equation 4 can be obtained by multiplying B⁻U′ to both sides.

vⱼ=B⁻U′sⱼ Equation 4:

Diagonal matrix B⁻ is straightforward to obtain, and it contains the reciprocals of the diagonal values of B, and the other entries will be equal to 0. To obtain vⱼ, the first r columns of B⁻ and the first r rows of U′ (equivalently, r columns of U) need to be computed. The dimensionality of vⱼ is r×1 (=r×r×r×m×m×1).

The equations 3 and 4 for sⱼ and vⱼ allow the user to move back and forth between the original data S and the map of targets V. Depending on the size of r, these formulae can result in the possible loss of information due to the fact the user can use only r dimensions. However, the matrices preserve the relationships between the original data and the map the user has derived.

According to the other aspect of the present disclosure, the user can introduce a new product on the map and determine the corresponding attribute values. The new product can be denoted as n+1, and the position on the map of the new product can be denoted as vₙ₊₁ From the equation 3, the following equation 5 can be obtained. From the equation 5, attribute values sₙ₊₁ of the new product located at any point vₙ₊₁ on the map can be computed and used for further analysis.

sₙ₊₁=(UB)ᵣvₙ₊₁ Equation 5:

According to the other aspect of the present disclosure, the user can also introduce a new product by directly specifying its attributes sₙ₊₁ and see the corresponding position of the new product on the map. The attributes for the new product sₙ₊₁ are given by the user. Using the least squares solution of equation 6 below, an R-squared value is computed. R-squared value, denoted R², is the regression sum of squares divided by the total sum of squares.

w=(S′S)⁻¹S′sₙ₊₁ Equation 6:

The vector w′=(w₁, w₂, . . . wₙ) is obtained via equation 6 as the least squares solution for a given data set S and sₙ₊₁, and allows the new product (n+1) to be represented as a weighted sum of the attribute values of the other n products, as given in equation 7.

sₙ₊₁(p)=w₁s₁+w₂s₂+ . . . +wₙsₙ Equation 7:

R²=1−(SSR/SSE) Equation 8:

Predicted value of sₙ₊₁ is denoted as sₙ₊₁(p) and sₙ₊₁(p) can be computed from equation 7 above. Average value of sₙ₊₁ is denoted as sₙ₊₁(A). SSR (sum of squares regression) can be computed by taking the difference between each element of sₙ₊₁ and the corresponding sₙ₊₁(p), squaring and then adding up all the squares. Likewise, SSE (sum of squares for error) can be calculated as the difference for each element of sₙ₊₁ from sₙ₊₁(A), squaring the difference, and adding them up.

vₙ₊₁=w₁B⁻U′s₁+w₂B⁻U′s₂+ . . . +wₙB⁻U′sₙ Equation 9:

If R² is greater than a predetermined value, then it means that the new product can be meaningfully incorporated within the map, and the position of the new product on the map vₙ₊₁ can be calculated according to equation 9. The predetermined value of R² can be, for instance, equal to 0.8 and if R²>0.8, then equation 9 can be used. In this case, the position of the new product vₙ₊₁ can be well represented as a linear combination of the positions of the other n products on the map.

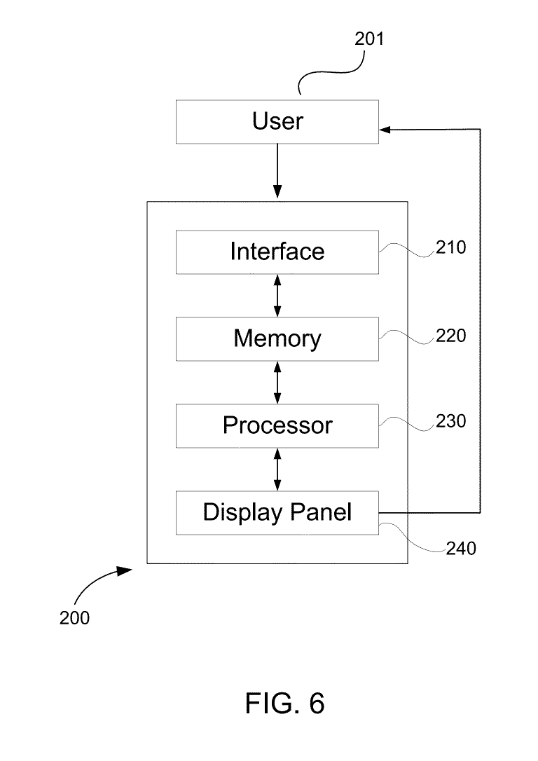

FIG. 6 is a diagrammatic illustration of a system for performing a reverse mapped position analysis according to an exemplary disclosed embodiment. A system 200 for performing a reverse mapping analysis includes an interface 210, a memory 220, a processor 230, and a display panel 240. Interface 210 is a space where system 200 interacts with a user 201 and system 200 receives the user's instruction. Memory 220 is any type of medium that can store programs (sequences of instructions) or data on a temporary or permanent basis for use in a digital electronic device. Memory 220 can includes Random-Access Memory (RAM), Dynamic Random-Access Memory (DRAM), Static Random-Access Memory (SRAM), Read Only Memory (ROM), Programable Read-Only Memory (PROM), Erasable Programmable Read Only Memory (EPROM), Electrically Erasable Programmable Read-Only Memory (EEPROM) type memory or tape, magnetic disck or optical discs (CD-ROM and DVD ROM). Processor 230 is configured to perform any or all of the steps, operations, or processes, for instance, required in Equations 1-9 as disclosed above. Display panel 240 is an output device for any visual representation of a set of information.

System 200 for performing a reverse mapping analysis stores at least one of perceptual data and preference data in memory 220. The perceptual data includes a plurality of attributes of a plurality of targets and the perceptual data are reflective of perceptions of a plurality of respondents for different attribute levels of the attributes. The preference data includes a plurality of preferences of the plurality of targets and the preference data are reflective of preferences of the plurality of respondents for different targets. System 200 generates a visual representation of at least one of the perceptual map and the preference map on display panel 240. The perceptual map is reflective of the perceptual data, and the preference map is reflective of the preference data. The System 200 is configured to receive at least one of 1) a relocated first position of one of the plurality of targets on the visual representation, 2) a second position of a new target on the visual representation, and 3) a change of a set of attribute levels of one of the plurality of targets from a user through interface 210. System 200 calculates at processor 230 and provides at least one of 1) a first set of attribute levels for the first position, 2) a second set of attribute levels for the second position, and 3) a third position on the visual representation for the change of set of attribute levels correspondingly to the information received from the user through interface 210.

It is to be understood that the exemplary embodiments described herein are that for presently preferred embodiments and thus should be considered in a descriptive sense only and not for purposes of limitation. Descriptions of features or aspects within each embodiment should typically be considered as available for other similar features or aspects in other embodiments.

What is claimed is:

1. A method for performing a reverse mapping analysis, comprising:
storing at least one of perceptual data and preference data in a computer memory storage,
the perceptual data including a plurality of attributes of a plurality of targets, wherein the perceptual data are reflective of perceptions of a plurality of respondents for different attribute levels of the attributes, and
the preference data including a plurality of preferences of the plurality of targets, wherein the preference data are reflective of preferences of the plurality of respondents for different targets;
generating a visual representation of at least one of a perceptual map and a preference map on a display device,
wherein the perceptual map is reflective of the perceptual data, and
wherein the preference map is reflective of the preference data;
receiving, from a user, at least one of
a relocated first position of one of the plurality of targets on the visual representation,
a second position of a new target on the visual representation, and
a change of a set of attribute levels of one of the plurality of targets;
calculating and providing, correspondingly, at least one of
a first set of attribute levels for the first position,
a second set of attribute levels for the second position, and
a third position on the visual representation for the change of set of attribute levels.

2. The method according to claim 1, wherein the input data for the perceptual map are an m by n matrix S, where m is the number of the attributes and n is the number of the targets, U is an m×m matrix containing the orthonormal basis vectors, B is an m×n matrix, and transpose of an orthogonal matrix V′ is an n×n matrix, and wherein S, U, B, and V′ satisfy S=UBV′.

3. The method according to claim 2, wherein the method of calculating and providing a second set of attribute levels sⱼ can be calculated for the given first position vⱼ, wherein the plurality of attributes are an m by n matrix S*, a first r columns of V represent the first position, a first r columns of UB represent the attribute vectors, and S*, UB, and V′ satisfy S*=(UB)ᵣ(V′)ᵣ, wherein jth row of matrix V is vⱼ, a column of S* is sⱼ, and wherein vⱼ, B, U, and sⱼ satisfy sⱼ=(UB)ᵣvⱼ.

4. The method according to claim 2, wherein the method of calculating and providing a second position vⱼ on the visual representation can be calculated from the given first set of attribute levels sⱼ, wherein the plurality of attributes are an m by n matrix S*, a first r columns of V represent the second position, a first r columns of UB represent the attribute vectors, and S*, UB, and V′ satisfy S*=(UB)ᵣ(V′)ᵣ, wherein jth row of matrix V is vⱼ, a column of S* is sⱼ, and wherein vⱼ, B, U, and sⱼ satisfy vⱼ=B⁻U′sⱼ.

5. The method according to claim 2, wherein the first position vₙ₊₁ on the visual representation is a position of a new target, and wherein attribute values sₙ₊₁ of the new target can be computed by an equation of sₙ₊₁=(UB)ᵣvₙ₊₁

6. The method according to claim 2, wherein the first set of attribute levels sₙ₊₁ is given for a new target position vₙ₊₁, and wherein the new target position vₙ₊₁ can be computed by an equation of vₙ₊₁=w₁B⁻U′s₁+w₂B⁻U′s₂+ . . . +wₙB⁻U′sₙ,

7. The method according to claim 5, wherein predicted value of sₙ₊₁ is sₙ₊₁(p), where sₙ₊₁(p)=w₁s₁+w₂s₂+ . . . +wₙsₙ, and average value of sₙ₊₁ is sₙ₊₁(A), wherein SSR (sum of squares regression) can be computed by taking the difference between each element of sₙ₊₁ and the corresponding sₙ₊₁(p), squaring and adding up all the squares, wherein SSE (sum of squares for error) can be calculated by taking the difference between each element of sₙ₊₁ and the corresponding sₙ₊₁(A), squaring and adding up all the squares, and wherein R²=1−(SSR/SSE) and if R²>0.8, the new target position vₙ₊₁ can be obtained by an equation of vₙ₊₁=w₁B⁻U′s₁+w₂B⁻U′s₂+ . . . +wₙB⁻U′sₙ.

8. A non-transitory computer-readable storage medium storing a program that, when executed by a computer, causes the computer to perform a process comprising:
storing at least one of perceptual data and preference data in a computer memory storage,
the perceptual data including a plurality of attributes of a plurality of targets, wherein the perceptual data are reflective of perceptions of a plurality of respondents for different attribute levels of the attributes, and
the preference data including a plurality of preferences of the plurality of targets, wherein the preference data are reflective of preferences of the plurality of respondents for different targets;
generating a visual representation of at least one of a perceptual map and a preference map on a display device,
wherein the perceptual map is reflective of the perceptual data, and
wherein the preference map is reflective of the preference data;
receiving, from a user, at least one of
a relocated first position of one of the plurality of targets on the visual representation,
a second position of a new target on the visual representation, and
a change of a set of attribute levels of one of the plurality of targets;
calculating, at a processor, and providing, correspondingly, at least one of
a first set of attribute levels for the first position,
a second set of attribute levels for the second position, and
a third position on the visual representation for the change of set of attribute levels.

9. The non-transitory computer-readable storage medium of claim 8, wherein the input data for the perceptual map are an m by n matrix S, where m is the number of the attributes and n is the number of the targets, U is an m×m matrix containing the orthonormal basis vectors, B is an m×n matrix, and transpose of an orthogonal matrix V′ is an n×n matrix, and wherein S, U, B, and V′ satisfy S=UBV′, wherein the method of calculating and providing a second set of attribute levels sⱼ can be calculated for the given first position vⱼ, wherein the plurality of attributes are an m by n matrix S*, a first r columns of V represent the first position, a first r columns of UB represent the attribute vectors, and S*, UB, and V′ satisfy S*=(UB)ᵣ(V′)ᵣ,wherein jth row of matrix V is vⱼ, a column of S* is sⱼ, and wherein vⱼ, B, U, and sⱼ satisfy sⱼ=(UB)ᵣvⱼ.

10. The non-transitory computer-readable storage medium of claim 9, wherein the input data for the perceptual map are an m by n matrix S, where m is the number of the attributes and n is the number of the targets, U is an m×m matrix containing the orthonormal basis vectors, B is an m×n matrix, and transpose of an orthogonal matrix V′ is an n×n matrix, and wherein S, U, B, and V′ satisfy S=UBV′, wherein the method of calculating and providing a second position vⱼ on the visual representation can be calculated from the given first set of attribute levels s, wherein the plurality of attributes are an m by n matrix S*, a first r columns of V represent the second position, a first r columns of UB represent the attribute vectors, and S*, UB, and V′ satisfy S*=(UB)ᵣ(V′)ᵣ, wherein jth row of matrix V is vⱼ, a column of S* is sⱼ, and wherein vⱼ, B, U, and sⱼ satisfy vⱼ=B⁻U′sⱼ.

11. The non-transitory computer-readable storage medium of claim 9, wherein the input data for the perceptual map are an m by n matrix S, where m is the number of the attributes and n is the number of the targets, U is an m×m matrix containing the orthonormal basis vectors, B is an m×n matrix, and transpose of an orthogonal matrix V′ is an n×n matrix, and wherein S, U, B, and V′ satisfy S=UBV′, wherein the first position vₙ₊₁ on the visual representation is a position of a new target, and wherein attribute values sₙ₊₁ of the new target can be computed by an equation of sₙ₊₁=(UB)ᵣvₙ₊₁, wherein the first set of attribute levels sₙ₊₁ is given for a new target position vₙ₊₁, and wherein the new target position vₙ₊₁ can be computed by an equation of vₙ₊₁=w₁B⁻U′s₁+w₂B⁻U′s₂+ . . . +wₙB⁻U′sₙ, wherein predicted value of sₙ₊₁ is sₙ₊₁(p), where sₙ₊₁(p)=w₁s₁+w₂s₂+ . . . . +wₙsₙ, and average value of sₙ₊₁ is sₙ₊₁(A), wherein SSR (sum of squares regression) can be computed by taking the difference between each element of sₙ₊₁ and the corresponding sₙ₊₁(p), squaring and adding up all the squares, wherein SSE (sum of squares for error) can be calculated by taking the difference between each element of sₙ₊₁ and the corresponding sₙ₊₁(A), squaring and adding up all the squares, and wherein R²=1−(SSR/SSE) and if R²>0.8, the new target position vₙ₊₁ can be obtained by an equation of vₙ₊₁=w₁B⁻U′s₁+w₂B⁻U′s₂+ . . . +wₙB⁻U′sₙ.

12. A method for performing a reverse mapping analysis, comprising:
storing at least one of perceptual data and preference data in a computer memory storage,
the perceptual data including a plurality of attributes of a plurality of targets, wherein the perceptual data are reflective of perceptions of a plurality of respondents for different attribute levels of the attributes, and
the preference data including a plurality of preferences of the plurality of targets, wherein the preference data are reflective of preferences of the plurality of respondents for different targets;
generating a visual representation of at least one of a perceptual map and a preference map,
wherein the perceptual map is reflective of the perceptual data, and
wherein the preference map is reflective of the preference data;
receiving, from a user, at least one of
a relocated first position of one of the plurality of targets on the visual representation,
a second position of a new target on the visual representation, and
a change of a set of attribute levels of one of the plurality of targets;
calculating and providing, correspondingly, at least one of
a first set of attribute levels for the first position,
a second set of attribute levels for the second position, and
a third position on the visual representation for the change of set of attribute levels,
wherein the input data for the perceptual map are an m by n matrix S, where m is the number of the attributes and n is the number of the targets, U is an m×m matrix containing the orthonormal basis vectors, B is an m×n matrix, and transpose of an orthogonal matrix V′ is an n×n matrix, and wherein S, U, B, and V′ satisfy S=UBV′,
wherein the method of calculating and providing a second set of attribute levels sⱼ can be calculated for the given first position vⱼ, wherein the plurality of attributes are an m by n matrix S*, a first r columns of V represent the first position, a first r columns of UB represent the attribute vectors, and S*, UB, and V′ satisfy S*=(UB)ᵣ(V′)ᵣ,
wherein jth row of matrix V is vⱼ, a column of S* is sⱼ , and wherein vⱼ, B, U, and sⱼ satisfy sⱼ=(UB)ᵣvⱼ,
wherein the method of calculating and providing a second position vⱼ on the visual representation can be calculated from the given first set of attribute levels sⱼ, wherein the plurality of attributes are an m by n matrix S*, a first r columns of V represent the second position, a first r columns of UB represent the attribute vectors, and S*, UB, and V′ satisfy S*=(UB)ᵣ(V′)ᵣ,
wherein jth row of matrix V is vⱼ, a column of S* is sⱼ , and wherein B, U, and sⱼ satisfy vⱼ=B⁻U′sⱼ, wherein the first position vₙ₊₁ on the visual representation is a position of a new target, and wherein attribute values sₙ₊₁ of the new target can be computed by an equation of sₙ₊₁=(UB)ᵣvₙ₊₁, wherein the first set of attribute levels sₙ₊₁ is given for a new target position vₙ₊₁, and wherein the new target position vₙ₊₁ can be computed by an equation of vₙ₊₁=w₁B⁻U′s₁+w₂B⁻U′s₂+ . . . +wₙB⁻U′sₙ,
wherein predicted value of sₙ₊₁ is sₙ₊₁(p), where sₙ₊₁(p)=w₁s₁+w₂s₂+ . . . +wₙsₙ, and average value of sₙ₊₁ is sₙ₊₁(A), wherein SSR (sum of squares regression) can be computed by taking the difference between each element of sₙ₊₁ and the corresponding sₙ₊₁(p), squaring and adding up all the squares, wherein SSE (sum of squares for error) can be calculated by taking the difference between each element of sₙ₊₁ and the corresponding sₙ₊₁(A), squaring and adding up all the squares, and
wherein R²=1−(SSR/SSE) and if R²>0.8, the new target position vₙ₊₁ can be obtained by an equation of vₙ₊₁=w₁B⁻U′s₁+w₂B⁻U′s₂+ . . . +wₙB⁻U′sₙ.
